(19) United States
(12) Patent Application Publication
(10) Pub. No.: US 2017/0296435 A1
(43) Pub. Date: Oct. 19, 2017

(54) SMART CONTAINER FOR ENHANCING INTENDED MOVEMENTS OF AN OBJECT

(71) Applicant: LuminX Corporation, Rancho Santa Fe, CA (US)

(72) Inventors: Noam A. Ziv, Solana Beach, CA (US); Maya Ziv, Solana Beach, CA (US); Jonathan Taub, Rancho Santa Fe, CA (US); Donald Jones, Cardiff-By-The-Sea, CA (US)

(21) Appl. No.: 15/490,836

(22) Filed: Apr. 18, 2017

Related U.S. Application Data
(60) Provisional application No. 62/323,923, filed on Apr. 18, 2016.

(51) Int. Cl. A61J 7/02; A61J 7/04; A61J 7/00; G06F 19/00; G08B 25/10; G08B 21/18

(52) U.S. Cl. CPC A61J 7/02; G08B 25/10; G08B 21/18; A61J 7/0076; G06F 19/3456; A61J 7/04; A61J 2200/30

(57) ABSTRACT

Certain aspects of the present disclosure provide a platform for monitoring patient adherence to a medical regimen. Certain aspects of the present disclosure also proved various components that may help enable such a platform, such as a smart collar capable of detecting removal and/or insertion of objects from a container (such as a pill container). In some cases, a smart collar may include a first portion having sides adapted to guide objects toward an opening in the first portion sized to allow the objects to pass, at least one detector proximate the opening and responsive to removal of objects from the container as they pass through the opening in the first portion, and a processor configured to process a first signal generated by the detector to update a monitored count of objects in the container.

### CROSS-REFERENCE TO RELATED APPLICATIONS

This application claims priority to U.S. Provisional Application No. 62/323,923 entitled “MECHANICAL DESIGN OF SMART COLLAR FOR TRACKING PATIENT ADHERENCE” filed Apr. 18, 2016, the disclosure of which is hereby expressly incorporated in its entirety by reference herein.

### BACKGROUND

### Field of the Disclosure

Certain aspects of the present disclosure generally relate to healthcare and, more particularly, to mechanisms for monitoring and/or promoting patient adherence with a prescribed regimen.

### Description of Related Art

Patient adherence generally refers to how well a patient takes medication, according to a regimen prescribed by a healthcare provider. In other words, patients are considered adherent when they take the prescribed medications at doses and times according to the regimen. Patient adherence is obvious a key component of treatment success. Non-adherence can lead to poor patient outcome and increased health costs.

As patient non-adherence has been recognized a contributing factor in rising health care costs, recent efforts have been made to monitor patient adherence. Such monitoring has a potential to help reduce cost and improve patient health by improving the effectiveness of care delivered. Such monitoring may help distinguish between poor treatment response and patient non-adherence. As such, monitoring adherence may help guide providers in prescribing decisions, identifying causes of non-adherence, and take measures to promote adherence.

Conventional mechanisms for monitoring adherence include clinical assessments, where patient usage is observed and recorded, and patient self-reporting. Each of these mechanisms has their own drawbacks. For example, clinical assessments of patient adherence are typically inconvenient, costly, and time-consuming, while patient self-reporting is notoriously unreliable.

For these reasons, improved mechanisms for monitoring and/or promoting patient adherence are desirable.

### SUMMARY

The systems, methods, and devices of the disclosure each have several aspects, no single one of which is solely responsible for its desirable attributes. Without limiting the scope of this disclosure as expressed by the claims which follow, some features will now be discussed briefly. After considering this discussion, and particularly after reading the section entitled “Detailed Description” one will understand how the features of this disclosure provide advantages that include improved communications in a wireless network.

Aspects of the present disclosure provide in some cases, a smart collar may include a first portion having sides adapted to guide objects toward an opening in the first portion sized to allow the objects to pass, at least one detector responsive to removal of objects from the container as they pass through the opening in the first portion, and a processor configured to process a first signal generated by the detector to update a monitored count of objects in the container.

Certain aspects of the present disclosure also provide various methods, apparatus, and computer-program products for performing operations performed by the apparatus described above.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

Aspects of the present disclosure provide an apparatus for tracking a count of objects in a container, comprising: a first portion adapted to be inserted within an opening of the container, the first portion having one or more surfaces adapted to guide the objects toward an opening in the first portion, the opening having a size configured to allow the objects to pass through the first portion, wherein one of the one or more surfaces has a slope that is different than another one of the one or more surfaces, the slope being determined relative to a common geometric plane; a detector circuit configured to: detect removal of at least one object from the container as the object passes through the opening, and generate a first signal in response to the detected removal of the at least one object; and a processor configured to update a count of the objects in the container based on the first signal.

Aspects of the present disclosure provide a method for tracking a count of objects in a container, the method comprising: inserting a first portion at an opening of the container, the first portion having one or more surfaces adapted to guide the objects toward an opening in the first portion, the opening having a size configured to allow the objects to pass through the first portion, wherein one of the one or more surfaces has a slope that is different than another one of the one or more surfaces, the slope being relative to a common geometric plane; detecting removal of at least one object from the container as the object passes through the opening; generating a first signal in response to the detected removal of the at least one object; and updating a count of the objects in the container based on the first signal.

Aspects of the present disclosure provide an apparatus for tracking a count of objects in a container, comprising: means for funneling the objects in the container, the funneling means configured to guide the objects toward an opening in the funneling means, the opening having a size configured to allow the objects to pass therethrough, the funneling means comprising one or more surfaces, wherein one of the one or more surfaces has a slope that is different than another one of the one or more surfaces, the slope being relative to a common geometric plane; means for detecting removal of at least one object from the container as the object passes through the opening; means for generating a first signal in response to the detected removal of the at least one object; and means for updating a count of the objects in the container based on the first signal.

### BRIEF DESCRIPTION OF THE DRAWINGS

FIG. 1 illustrates a diagram of an example adherence monitoring platform, in accordance with certain aspects of the present disclosure.

FIG. 2 illustrates a diagram of an example adherence monitoring platform, in accordance with certain aspects of the present disclosure.

FIG. 3 illustrates example operations for monitoring object removal (and/or insertion) from a container, in accordance with certain aspects of the present disclosure.

FIG. 4 illustrates example operations for updating adherence information, in accordance with certain aspects of the present disclosure.

FIG. 5A illustrates an example sequence of operations for updating adherence information via a container with a smart collar, in accordance with certain aspects of the present disclosure.

FIG. 5B illustrates an example sequence of operations for communicating an alert based on adherence information via a container with a smart collar, in accordance with certain aspects of the present disclosure.

FIG. 6 illustrates an example container with a smart collar for monitoring removal and/or insertion of items from the container, in accordance with certain aspects of the present disclosure.

FIG. 7A illustrates an example smart collar with one or more sensors to detect travel of an object (such as a pill) from an opening of the smart collar, in accordance with certain aspects of the present disclosure.

FIG. 7B illustrates an example arrangement of one or more sensors, in accordance with certain aspects of the present disclosure.

FIG. 7C illustrates another example arrangement of one or more sensors, in accordance with certain aspects of the present disclosure.

FIG. 8 illustrates an example schematic diagram of a smart collar, in accordance with aspects of the present disclosure.

FIG. 9 illustrates one example of a smart collar, in accordance with aspects of the present disclosure.

FIGS. 10A and 10B illustrate different perspective views of the example smart collar shown in FIG. 9.

FIGS. 11A and 11B illustrate examples of funnel portions of a smart collar with different size and/or shaped openings.

FIGS. 12A and 12B illustrate examples of mount portions of a smart collar with different size and/or shaped openings.

FIGS. 13A and 13B illustrate examples of top portions of a smart collar with different size and/or shaped openings.

FIGS. 14 and 15A-15C illustrates different views of another example of a smart collar, in accordance with aspects of the present disclosure.

FIGS. 16A-16C illustrates different views of still another example of a smart collar, in accordance with aspects of the present disclosure.

FIGS. 17A-17B illustrates the smart collar of FIGS. 15A-15C inserted into the container of FIG. 1, in accordance with aspects of the present disclosure.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

Aspects of the present disclosure generally relate to a platform for monitoring patient adherence to a medical regimen. Aspects of the present disclosure also relate to various components that may help enable such a platform, such as a smart collar that can detect and communicate information related to adherence. As described herein, a smart collar that seamlessly integrates with a medicine container may result in a cost-effective mechanism to communicate accurate (e.g., on the order of per-pill accuracy) information regarding patient adherence.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

The word “exemplary” is used herein to mean “serving as an example, instance, or illustration.” Any aspect described herein as “exemplary” is not necessarily to be construed as preferred or advantageous over other aspects.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

### An Example Platform for Monitoring Patient Adherence

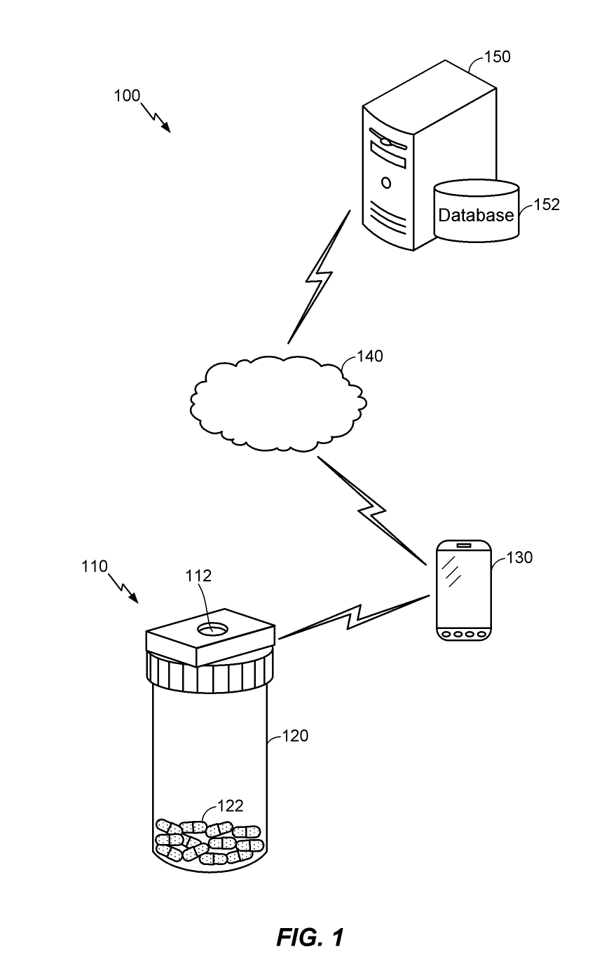

FIG. 1 illustrates a system 100 in which aspects of the disclosure may be performed. The system 100 may be considered a cloud-based platform for monitoring patient adherence.

In the illustrated example, a smart collar 110 may be fitted to a container 120 and configured to monitor the removal and/or insertion of objects 122 from the container 120. As will be described in greater detail below, the smart collar 110 may include one or more sensors (such as photo-interrupter) capable of detecting the removal and/or insertion of objects (or any detectable amount of container contents) through an opening 112.

As an illustrative, but not limiting example, the container 120 may be a pill bottle and the objects 122 may be pills. Thus, the smart collar 110 may maintain and update a pill count as pills are taken from or added to the container 120. In such cases, the smart collar 110 may be adapted to couple with standard size pill bottles (e.g., replacing standard lids) or with custom size pill bottles. The smart collar 110 may be a separate component or, in some cases, may be an integral part of a container 120. While a pill bottle is described to facilitate understanding, the techniques and mechanisms described herein may be used to monitor any type of detectable content (e.g., whether solid, liquid, or gas) removed from or added to a container.

The smart collar 110 may have one or more interfaces allowing communication with a network 140, such as a cloud computing network. As used herein, the term cloud computing generally refers to any type of network-based (e.g., Internet-based) computing that provides shared processing resources and data to devices on demand. As such, cloud computing may be considered a model for enabling on-demand access to a shared pool of configurable computing resources, which can be rapidly provisioned and released with minimal management effort.

Communications between a network 140 and the collar 110 are bi-directional and may be used to exchange event information, configuration, alerts, or other information.

In general, collar to network communications may be opportunistic and may occur via one or more paths, over multiple types of links (possibly wireless), either directly or indirectly (via gateway). In some cases, a device other than a mobile device may serve as a gateway to the cloud. For example, gateway functionality may be provided as part of another connected device (TV, thermostat, Echo, or the like).

In the present example, a cloud computing network may allow information from the smart collar 110 to be communicated (e.g., via packets or other type messages) to a server 150 that monitors patient adherence. Information related to a pill count may include, for example, an absolute or relative pill count, change in pill count, number or rate of pills taken over a given time period. Such information related to one or more patients may be stored in a database 152 and such information may be analyzed as part of an overall scheme to monitor and attempt to encourage patient adherence with a medical regimen.

The smart collar 110 may include any combination of interfaces to communicate with network 140 directly or indirectly. In the example illustrated in FIG. 1, the smart collar 110 may indirectly communicate with the network 140 via a mobile device 130 (such as a smart phone), for example, via Bluetooth, Bluetooth low energy (LE), ZigBee, Wi-Fi (or other type of wireless local area network-WLAN). The smartphone may run an application (app) that is configured to communicate with the smart collar 110, gather data and, in some cases, present adherence data to a patient and/or notifications to a patient.

As will be described in greater detail below, in some cases, such an app may also be used to view information regarding a medicine as an alternative (or in addition) to conventional printed (and sometimes difficult to read) documentation.

In some cases, the smart collar 110 may include local storage to store information such as medication regimen, the information for a particular medication, or other information.

Once provisioned with medication regimen information, local storage of allows autonomous collar operation when the network is not accessible.

In some cases, the cloud computing network may update information stored on the smart collar 110 such as medication regimen, the information for a particular medication (“booklet”), or other information. A smart collar described herein may accommodate such updates at home (e.g. with not need to visit a pharmacy), or at other locations (pharmacy or medical provider).

In some cases, in order to protect sensitive patient information, collar events, medication regimen, and other provisioned or collected information may be encrypted and saved locally, and may be deleted upon server command.

In some cases, devices other than the collar (e.g., apps on phones or TVs, laptops, security systems, thermostats, etc.) may be used to present informational content to the patient or person associated with the patient. Depending on the deployment, such information may or may not follow the same communication path as the server to collar communications. In some cases, once activated and provisioned, a collar may operate autonomously (e.g., without any server communication) and, in such cases, the collar may generate local informational content (e.g., using whatever capabilities it has) as well as collect and save event information (e.g., any suitable form of local memory). In some cases, such local alerts/storage may be performed only until a connection is obtained. In other cases, such local alerts/storage may be supplemental (e.g., performed regardless of connectivity).

As noted herein, certain medication (“booklet”) information may be stored locally to a collar. In such cases, such information may be accessed by connecting a viewer to the collar (app, TV, computer, refrigerator, or the likes).

In some cases, a collar may be provisioned to help users locate (“find”) it. In some cases, a collar may include other “user facing” features such as an “OK reminder” (e.g., indicating to a user they are in compliance and taking pills on time).

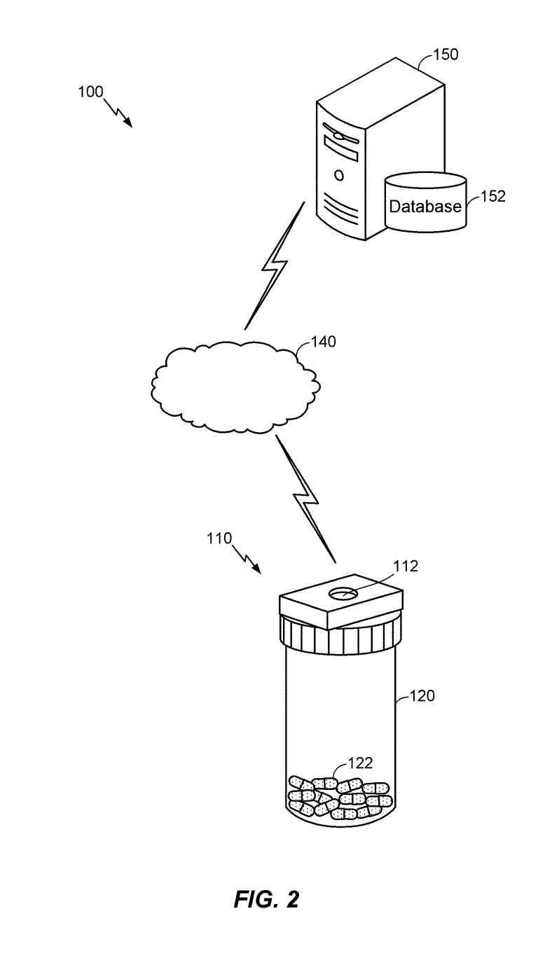

As illustrated in FIG. 2, in some cases, a smart collar may communicate via different types of connections, such as directly with the network 140 (e.g., without needing a separate device for connectivity). In some cases, a smart collar 110 may be capable of communicating both directly or indirectly with the network 140. In such cases, whether the smart collar 110 communicates directly or indirectly may be based on one or more conditions (e.g., channel conditions, a power savings mode, a state of a battery of the smart collar 110, and/or availability of a direct connection).

For such direct or indirect connectivity with the network 140, the smart collar 110 may include one or more radios (transceivers) that support one or more radio access technologies (RATs) or other type of wireless technologies (e.g., audio or light communications which may not need an antenna). In some cases, a particular RAT or RATs supported may be determined based on cost considerations. Examples of such RATs include, but are not limited to Bluetooth, Bluetooth low energy (LE), ZigBee, Wi-Fi (or other type of wireless local area network-WLAN), or Cellular (or other type of wireless wide area network-WAN). Thus, a wide variety of options exist for providing a gateway to connect the smart collar 110 to the network 140 directly or indirectly. In some cases, the smart collar may communicate using (piggyback on) one or more existing gateways, such as Amazon Echo, smart televisions with radios and networking, home automation and/or security systems, or using a dedicated Gateway (such as 2net).

In general, any suitable type of gateway or direct communications (or other type connectivity) may be supported to allow the smart collar 110 to communicate information via the network 140. As will be described in greater detail below, in some cases, two-way communication may be used between the collar and the cloud. For example, data may flow from the smart collar to the cloud (in an event driven manner) and data may also flow from the cloud to the smart collar (e.g., configuration information, notifications, or other type information).

As noted above, in some cases, the smart collar may provide functionality even during times when there is no connection to the cloud (times of Non-Connectivity). In such cases, the smart collar may be configured to collect and store data until a connection is gained. In some cases, once activated and configured, data collected by the collar may be encrypted and stored locally on the collar. Such data may be uploaded to the cloud opportunistically (e.g., when connectivity becomes available). In some cases, data may be erased from collar once cloud confirms correct receipt of that data (e.g., via an acknowledgement message).

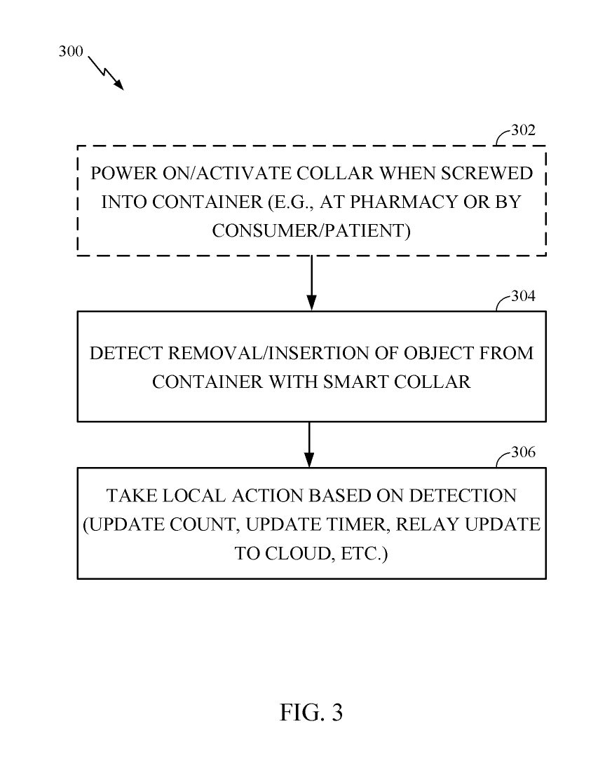

FIG. 3 illustrates example operations 300 for monitoring object removal (and/or insertion) from a container, in accordance with certain aspects of the present disclosure. The operations 300 may be performed, for example, via one or more components (e.g., sensors and processors) of the smart collar 110.

As illustrated at 302, in some cases, the smart collar may be powered on or activated when installed. For example, the smart collar may be powered on or activated when screwed into a pill bottle at a pharmacy or by the patient. In some cases, a smart collar may be activated during assembly/manufacture of a pre-packaged container (e.g., containing a fixed dosage of pills or other type medicine). In some cases, a bottle may be “provisioned” with information related to a particular patient medication regimen, type of medicine (e.g., pill type/size) as well as various other type of configuration information. At 304, the smart collar detects removal of an object from (and/or addition of an object to) the container. At 306, the smart collar takes action based on the detection.

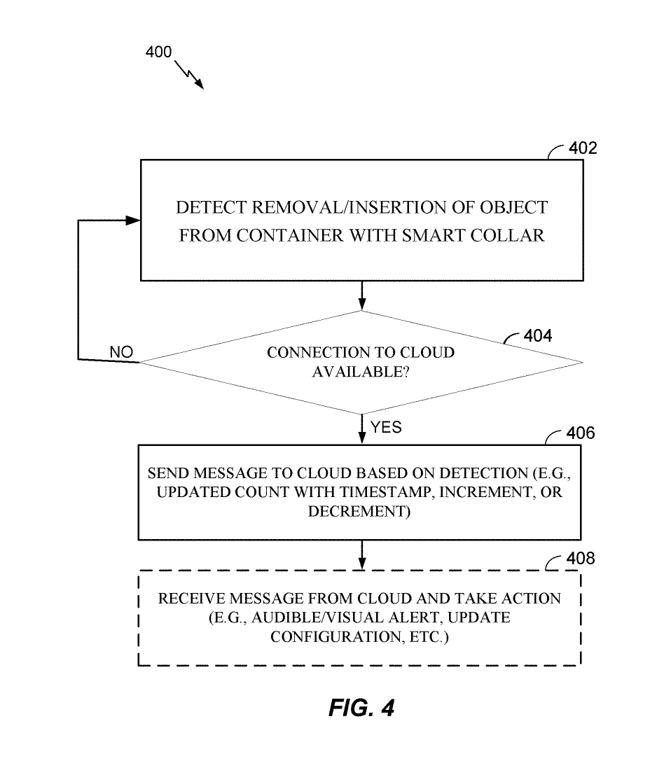

As described above and illustrated in operations 400 of FIG. 4, in some cases, the action taken may depend on current connectivity to the cloud. At 402, the smart collar detects removal of an object from (or addition of an object to) a container. If a connection to the cloud is not available, as determined at 404, for example, the smart collar may update and maintain a pill count locally and continue to detect a change in pill count.

Once a connection is available, at 406, the smart collar may send a message to the cloud. For example, the message may indicate an updated count, a change (increment or decrement) in pill count and may include a timestamp or an indication of a time period over which the count changed. As noted above, the message may be sent directly to the cloud or indirectly (e.g., via a smartphone).

Optionally, at 408, the smart collar may receive a message from the cloud and take action accordingly. The message, for example, may be generated in response to the adherence information sent (at 406). As an example, the message may be a reminder sent via the smartphone app described above (or sent directly to the smart collar). In some cases, the collar may have a mechanism to provide audible alerts (e.g., a speaker or buzzer) and/or visual alerts (e.g., via an LED or small display). As another example, the message may simply acknowledge the cloud received the message sent at 406 (e.g., and the smart collar may delete locally stored data in response to the acknowledgement).

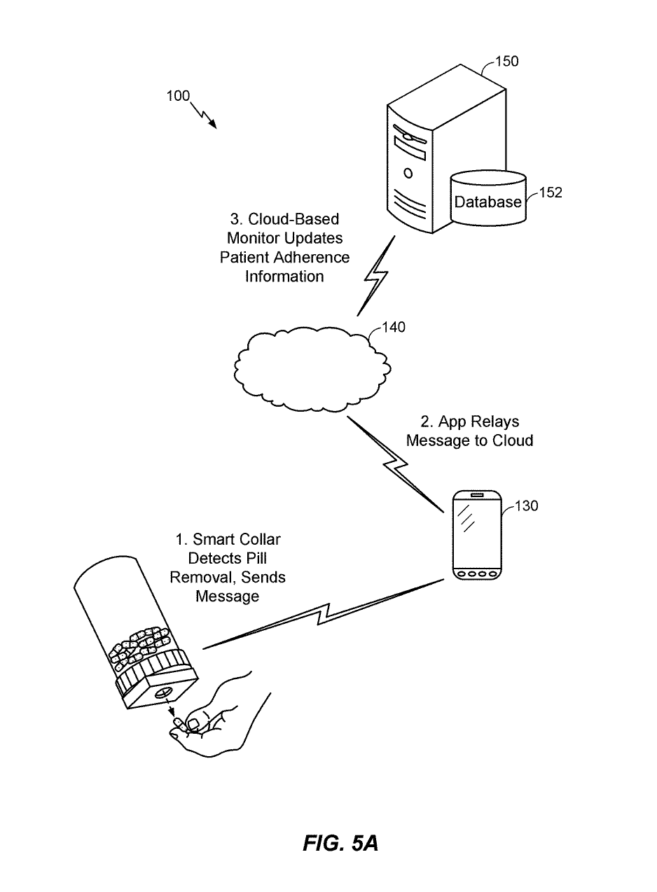

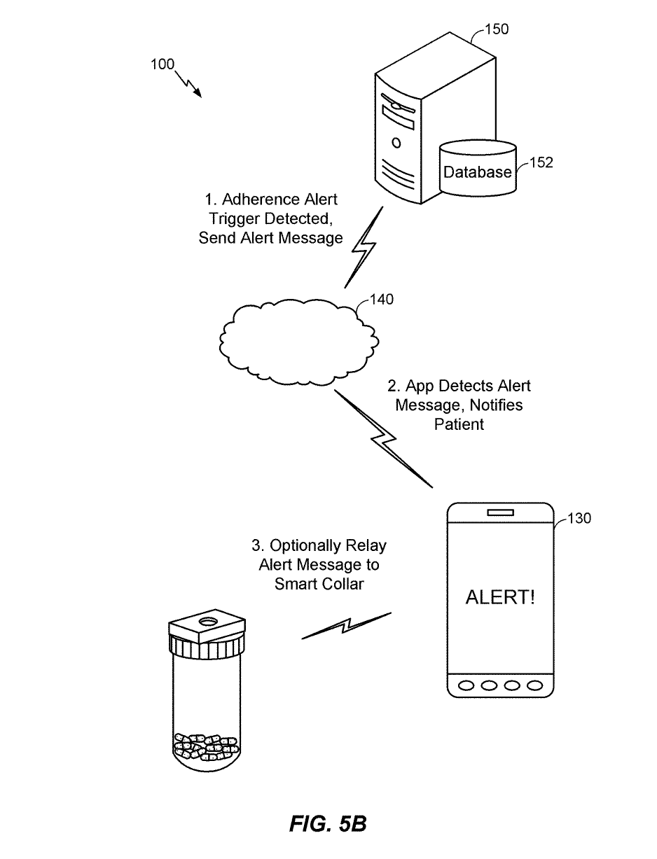

FIG. 5A illustrates an example sequence of operations for updating adherence information via a container with a smart collar, in accordance with certain aspects of the present disclosure. As illustrated, the smart collar may first detect pill removal and send a message to the cloud, relayed through a smartphone in this example. The cloud-based monitoring (e.g., at server 150) may then update patient adherence information accordingly (e.g., in database 152).

As illustrated in FIG. 5B, in some cases, the cloud-based monitoring may generate an alert message (or other notification) in response to some trigger event. For example, a simple reminder may be sent periodically if the server does not receive an update indicating a patient has taken medicine according to a prescribed regimen. As another example, the trigger event may be caused if a timer has expired indicating the patient is not adhering with a prescribed regimen (e.g., taking too few or too many pills). In the illustrated example, the smartphone app may relay such an alert message to the smart collar (e.g., which may provide an audible or visual alert to a patient). In some cases, providers (e.g., doctors) may actually be able to adapt a medical regimen based on the adherence information (and possibly based on other information, such as bio-informatics obtained for the patient).

While the illustrated examples of FIGS. 5A and 5B shows indirect communication between the smart collar 110 and the cloud (via wireless device 140), a similar sequence of messages could be exchanged directly between the cloud and smart collar (e.g., eliminating step 2 in both cases).

### An Example Smart Collar

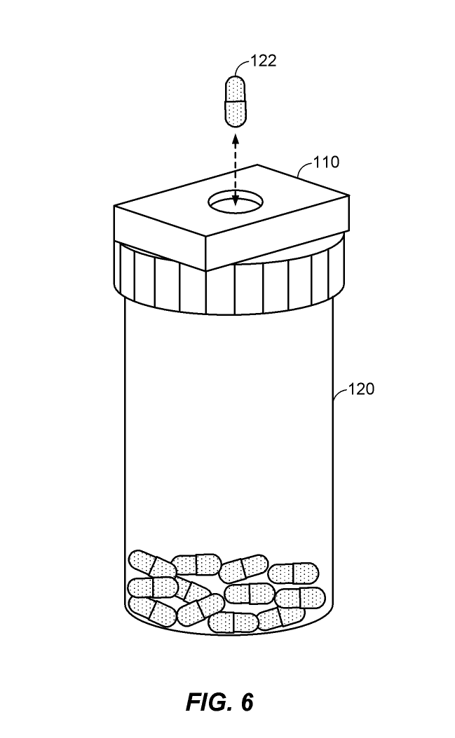

FIG. 6 illustrates an example container with a smart collar for monitoring removal and/or insertion of items from the container, in accordance with certain aspects of the present disclosure. As illustrated, the smart collar may seamless integrate with existing types of pill bottles.

In some cases, the smart collar may be automatically activated (turned on and begin monitoring/reporting) when attached to bottle. This activation may take place, for example, when configured with regimen and/or medicine information. In some cases, the collar may be designed to make it very difficult to remove once it is attached (e.g., via a mechanical device). This may allow for “lifetime tracking” of the container and/or its contents. In some cases, other sensor information (besides removal for adherence) may be monitored (e.g., over the lifetime). Examples of such sensor information may include humidity, temperature, impact, or even location (e.g., via GPS or other means).

In some cases, a sensor may detect removal and trigger an alarm and/or sending of a message. As noted above, the collar may record and report removal of pills from container 120. In some cases, the collar may include some type of visual tamper detection (e.g., such as the “twist off” caps with break-off rings sometimes used on certain types of bottles). Various other types of container (e.g., bottle) security may also be implemented, for example, for tamper detection as well as counterfeit detection (e.g., using a secure ID).

This monitoring functionality may be combined with certain “user facing” communications (e.g., alerts or other type notification). Such alerts/notification may be provided by any suitable techniques, for example, via the smartphone app or via a contact person/means identified by the platform. In some cases, the smart collar may include a mechanism for alerts, such as a buzzer or speaker for audible alerts and/or an LED or display for visual alerts.

In some cases, a collar may be provisioned with information that uniquely identifies the drug (e.g., drug type, manufacturer, date, location, and an authentication ID)—this may be in conjunction with the lifetime tracking mentioned above and may also be used to verify origin and authenticity of drug. Such provisioning may also include medication use guide/information.

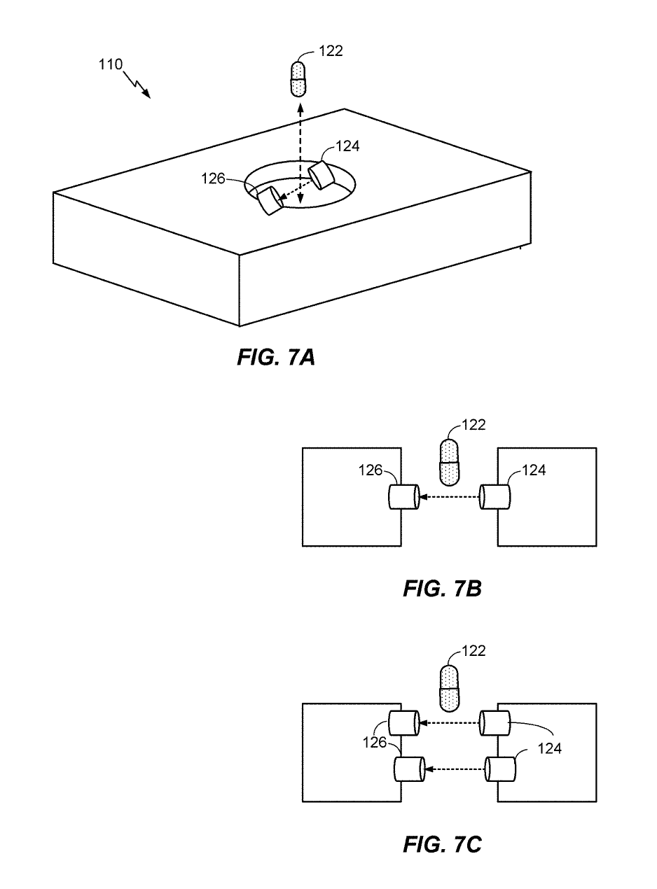

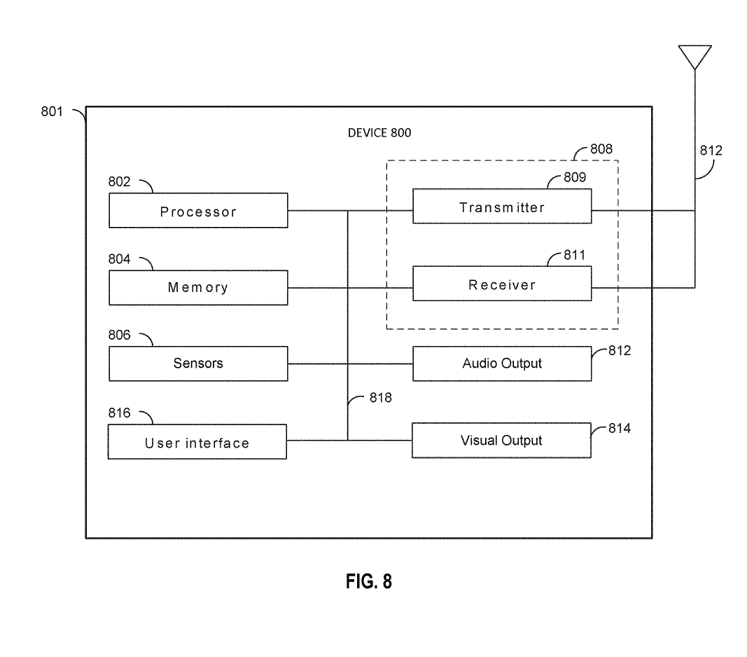

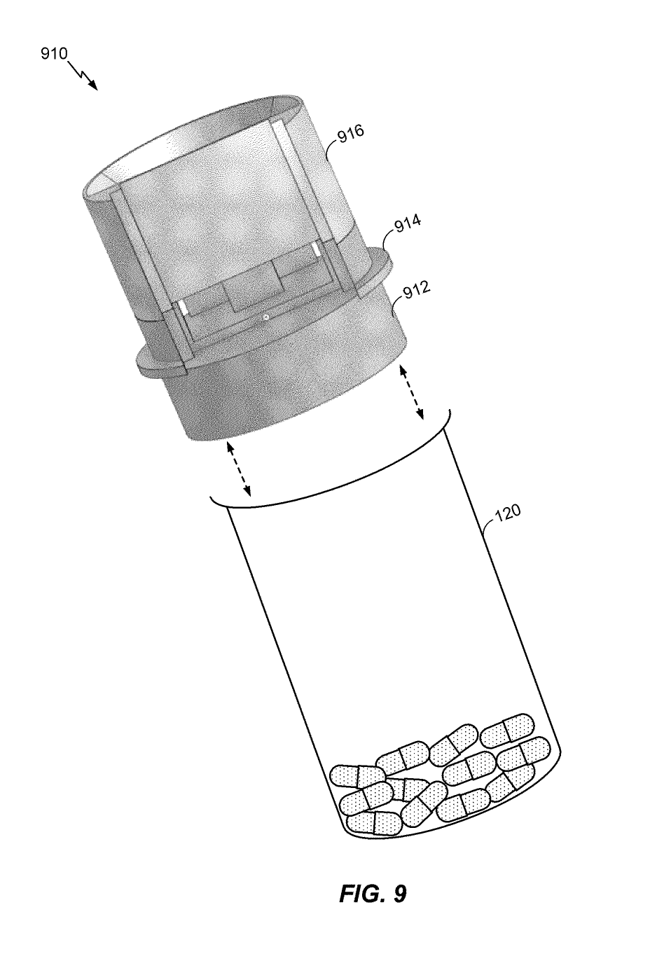

FIG. 7A-7C illustrates example smart collars with one or more sensors to detect travel of an object (such as a pill) from an opening of the smart collar, in accordance with certain aspects of the present disclosure. As noted above, for relatively low cost, a sensor arrangement may allow a smart collar to provide relatively accurate results (e.g., a pill count with “per-pill” resolution).

As illustrated in FIGS. 7A and 7B, one type of sensor arrangement may be a photo interrupter formed by an emitter 124 (e.g., LED) and a detector 126 (e.g., a phototransistor). In such a case, passage of a pill 122 (or other object) may be detected as an interruption in light (emitted from emitter 124) detected at detector 126. As illustrated in FIG. 7B, the emitter/detector pair may be located at an opening through which the object passes. In some cases, the removal (or insertion) of multiple pills may be detected by monitoring the signal (e.g., and how long the path is interrupted based on pill size).

As illustrated in FIG. 7C, in some cases, multiple photo interrupters may be offset (e.g., vertically) which may also help determine direction (to discern removal from insertion) based on which path is interrupted first. In some cases, multiple photo interrupters may also be offset at different angles about the opening, which may help provide more accurate results. More elaborate sensing schemes may also be used, albeit in some cases with an increased cost.

While the examples shown in FIGS. 7A-7C utilize a photo-interrupter, various other approaches may be used for pill counting. For example, various other types of optical sensors may be used, such as a one or more cameras or other imaging methods, placed in multiple topologies (centralized or distributed).

In some cases, rather than a photo interrupter (also known as a transmissive optical sensor), a reflective optical sensor may be used. Transmissive optical sensors detect an object when a light beam is interrupted. Reflective optical sensors measure the amount of light reflected by a passing object. Other types of mechanical or proximity sensors may also be used. In general, any suitable mechanism capable of detecting addition or removal of objects from a container (e.g., pills from a bottle) may be utilized.

In some cases, one type of sensor that may be included is an accelerometer. In such cases, the accelerometer may be used for various functions including: power management, discerning removal from insertion, and collecting information about bottle motion. In some cases, sensor fusion may be performed to improve event detection accuracy.

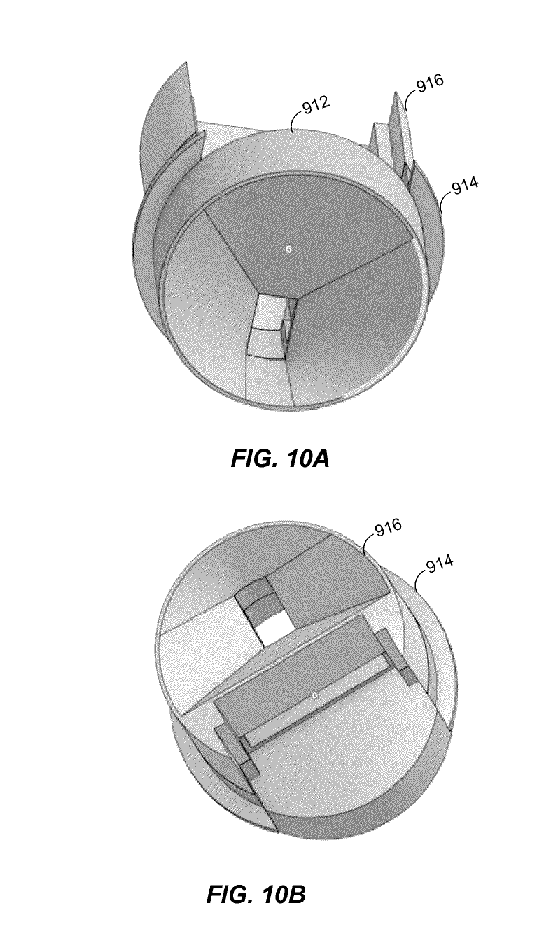

FIG. 8 illustrates an example schematic diagram of a smart collar 110, in accordance with aspects of the present disclosure. As illustrated, the smart collar may include a processor 802 and one or more wireless interfaces 808. As noted above, the wireless interfaces 808 may include any type of wireless interface suitable to allow the smart collar 110 to communicate directly or indirectly, via one or more antennas 810 with a cloud computing network.

The smart collar 110 may also include memory 804, for example, to store instructions executable by processor 802, to store configuration information, adherence information (e.g., pill count), or other type of information. As noted above, in some cases, memory 804 may include information regarding medication (dosage, precautions, and the like) as an alternative (or in addition) to information typically provided in print form.

Processor 802 may be configured to carry out operations described above. For example, the processor may help activate the smart collar 110 upon detecting its deployment (e.g., installation on a bottle) to begin monitoring of patient adherence. For example, processor 802 may receive input from sensors 806 (e.g., photo interrupters described above) to detect removal/insertion of pills. In addition, sensors 806 may include sensors for monitoring various other parameters (e.g., temperature, humidity, location, and the like).

As noted above, the smart collar 110 may also include mechanisms to provide audible and/or visual alerts. For example, the smart collar 110 may include a buzzer (or speaker) 812 to provide audible alerts and/or an LED (or display) 814 to provide visual alerts.

In some cases, processor 802 may take measures to conserve power, for example, so the smart collar can operate off a single battery for an extended period (e.g., years). To that end, the processor 802 may implement any combination of one or more power optimization techniques to conserve power while monitoring sensors and/or transmitting messages.

### Example Smart Collar Mechanical Components

In some cases, a smart collar may be designed with one or more components to help control or enhance movement of the contents as they are removed from or added to a container. Furthermore, the smart collar may be designed to provide a compact housing for the components of the smart collar.

For example, continuing with the pill bottle example, a smart collar may have mechanical features to guide pills toward an opening to facilitate detection of the pills by the sensor arrangement. For example, a bottom portion may be funnel shaped to guide pills to an opening (sized according to a particular pill) and try and ensure they are in a particular orientation (e.g., lengthwise) as they traverse the sensor path. The mechanical features, described in further detail below, may provide for dispensing of one or more pills with minimal movement and reduced need to shake the pill bottle. Furthermore, in some implementations, the mechanical features of the smart collar may be configured to be fitted to the pill bottle with minimal or no change in an appearance of the pill bottle. For example, a majority of the smart collar may be configured to fit inside the pill bottle or a neck of the pill bottle, such that the original appearance of the pill bottle is not changed with the inclusion of the smart collar. Alternatively, the smart collar may be configured to fit on top of the pill bottle.

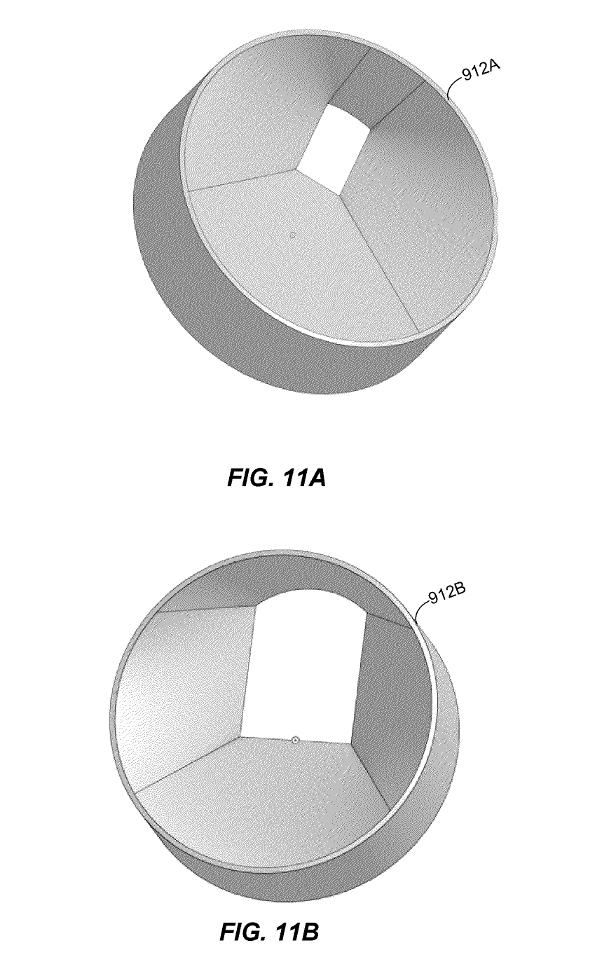

FIG. 9 illustrates one example of a smart collar 910, in accordance with aspects of the present disclosure, with separate components. As illustrated, the smart collar 910 may include a funnel portion 912, a mount portion 914, and a top (or dispensing) portion 916. The funnel portion 912 of the smart collar 910 may be positioned below the mount portion 914, which may be positioned below the top portion 916. In some embodiments, the positions of the components of the smart collar 910 may be changed or one or more components may be integrated or combined. For example, in some embodiments (not shown), the mount portion 914 may be positioned above or combined with the top portion 916, which may be positioned above the funnel portion 912. While the example shown in FIG. 9 has three separate components, other embodiments may have more or less than three separate components while still providing the same or similar functionality to control movement of objects dispensed from or added to the container 120.

In some embodiments, the funnel portion 912 may be configured to be inserted into the container 120. The funnel portion 912 may be configured to funnel pills from inside the container 120 to an outside of the container 120 while counting the number of pills that are dispensed from the container 120. Further details of the funnel portion 912 may be provided below. In some embodiments, the funnel portion 912 may be configured to funnel pills from the container 120 one at a time. Furthermore, the funnel portion 912 may be configured to ensure that the funneled pills are dispensed from the container 120 with at least some space between consecutive pills so that each pill may be counted as it is dispensed. The funnel portion 912 may be configured to dispense pills from the container 120 individually without blocking any of the pills from being dispensed. In some embodiments, the funnel portion 912 may be configured to house one or more electronic components of the smart collar 910, as will be described in more detail below.

In some embodiments, the funnel portion 912 may comprise one or more sloping surfaces. In some embodiments, the sloping surfaces of the funnel portion 912 may be smooth and may be configured to allow one or more pills to be dispensed with minimal movement or shaking and reduced need to shake the pill bottle. The extent of smoothness may be based on a surface's coefficient of friction. The coefficient of friction may be selected based on a value that is appropriate for removing objects from the container. In some embodiments, the sloping surfaces comprise little or no bumps or protrusions on the sloping surfaces.

In some embodiments, the sloping surfaces may have different slopes from one another. For example, the funnel portion 912 may comprise four sloping surfaces. In this example the slope of the first surface may be different than the slope of second, third, or fourth surfaces. In some embodiments, the angle or slope of the sloping surfaces is a function of or may be dependent on the pill size and/or shape. For example, the slope of one or more sloping surfaces may become steeper as the pill size increases. In some embodiments, the top portion 916 may comprise a funnel portion that is substantially similar to the funnel portion 912. In some embodiments, the funnel portion of the top portion 916 is configured to allow more efficient insertion of the pills because a patient does not need to locate the opening in order to insert the pills. Likewise, the funnel portion of the top portion 916 is configured to allow more efficient removal of pills from the container because the funnel portion of the top portion 916 may be configured to guide the pills from the container 120 to the patient's hand in a controlled manner when a patient tilts the container 120.

In some embodiments, the mount portion 914 may be configured to hold or mount the smart collar 910 to the container 120. For example, the mount portion 914 may be configured to rest on a top lip or portion of the container 120. Accordingly, when the mount portion 914 is positioned above the other components of the smart collar 910, then the funnel portion 912 may be positioned inside the container 120. The mount portion 914 may be configured to keep the smart collar 910 attached to the container 120 while ensuring that the smart collar 910 does not fall into the container 120. In some embodiments, the mount portion 914 may be configured to house one or more electronic components of the smart collar 910, as will be described in more detail below.

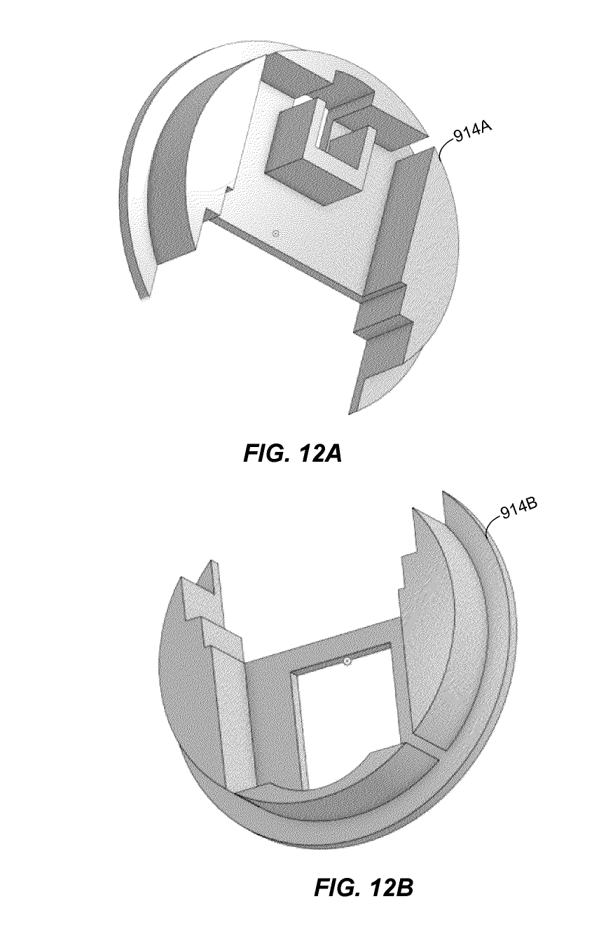

FIG. 10A is a bottom view of the smart collar 910, including the funnel portion 912, the mount portion 914, and the top portion 916. As shown in FIG. 10A, the funnel portion 912 may comprise one or more sides that are formed or shaped to guide pills from the container 120 to an opening in the funnel portion 912. The one or more sides of the funnel portion 912 may be configured to guide the pills from the container 120 in a controlled manner when a patient tilts the container 120. In some embodiments, the one or more sides may be coated with a material or may be configured to slow the dispensing of the pills such that only one pill at a time passes through the opening in the funnel portion 912. In some embodiments, though not shown, the funnel portion 912 may include one or more sensors (e.g., optical sensors) configured to detect a size and shape of any object that pass through the opening in the funnel portion 912. Accordingly, the one or more sensors of the funnel portion 912 may be configured and/or used to identify a contaminant placed within the container 120 by determining that an object with a different size, shape, etc., is placed within the container 120. In some embodiments, the funnel portion 912 may include one or more chemical or other detection sensors configured to determine that a contaminant has been introduced to the container 120. For example, the chemical sensor may detect a change in one or more chemicals detected inside the container 120 and may determine that the change in chemical indicates a contaminant has been introduced to the container 120.

FIG. 10B is a top view of the smart collar 910, including the top portion 916 and the mount portion 914. The top portion 916, as shown, may have sides shaped to gently guide the pills from the opening in a controlled manner, for example, into the hand of the patient. In some embodiments, the top portion 916 may include a cap, lid, or cover separate from the cap or cover of the container 120. In some embodiments, the top portion 916 may be configured to utilize the same cap or cover of the container 120 to minimize complexity for the patient.

As noted above, the funnel portion (not shown in this figure) may be shaped and sized to be inserted into the pill container. While many different sizes and shapes of pill containers exist, many of them have a lid/opening size of a common diameter. Thus, one funnel portion design may actually fit in different pill containers. Alternatively, or additionally, the smart collar 910 may be configured to fit in pill containers of varying sizes. In some embodiments, the smart collar 910 may include an expandible gasket configured to adjust in size to allow the smart collar 910 to fit on multiple sizes of pill containers. In some embodiments, multiple sizes of smart collars 910 may be manufactured and/or provided.

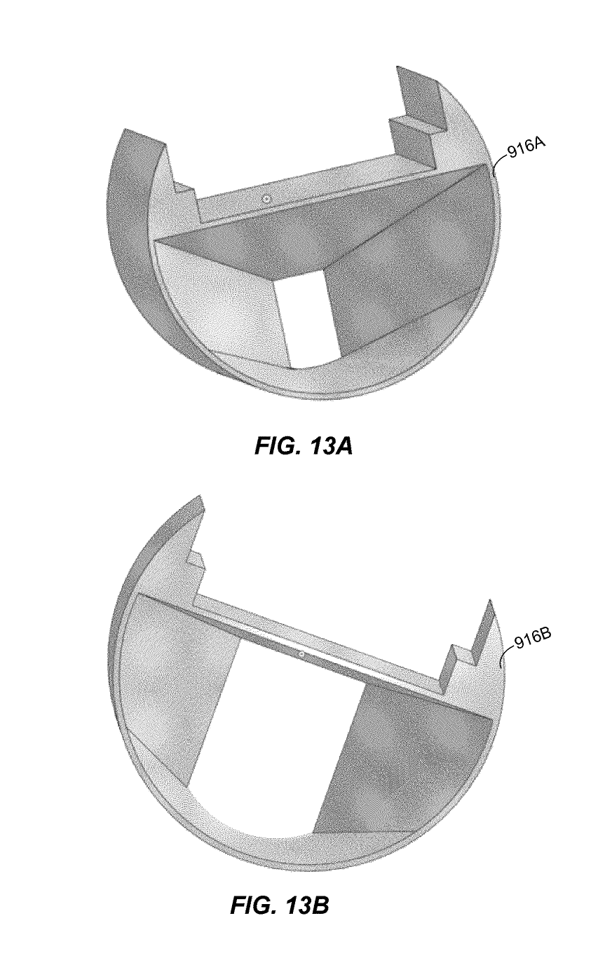

As illustrated in FIG. 11A and as described herein, the funnel portion 912 may include a shape and/or one or more sides configured to steer/direct pills from the pill container into an opening 913. In some embodiments, the opening 913 may pass through the smart collar 910 from the funnel portion 912 to the top portion 916, also passing through the mount portion 914. Thus, as the container is tilted, the angles of the one or more sloping surfaces of the funnel portion 912A may help direct the pills into the opening 913. This may help effectively “serialize” pill arrival at the openings, helping create a smoother flow which may lead to more accurate detection. The shapes of the surfaces also help orient the pills to better align with the opening. In some embodiments, the one or more sides of the funnel portion 912 may be curved to help orient or rotate the pills as they are dispensed. In some embodiments, though not shown in this figure, the openings may also be positioned at different locations in the funnel portion 912 (and thus the mounting portion 914 and the top portion 916).

In some embodiments, the design of openings in the funnel portion 912A may vary slightly with pill size or based on the medication or product being dispenced from the container. Example funnel portions 912A and 912B shown in FIGS. 11A and 11B have, for example, differently sized (and shaped) openings and sides. In some embodiments, dimensions of the funnel portion 912 may also be driven by the size of other components, such as the size of a battery and the electronic circuitry powered by the battery.

The mount (middle) portion 914 may be configured and/or designed to support an accurate placement of electronics, such as one or more photo interrupters, around the opening 913 for pill detection during dispensing of the pills. The mount portion 914 may also be configured and/or designed to ensure that the pills do not get “caught” or cause a “jam” when transitioning between the funnel portion 912 and the top portion as pills are removed (or between the top portion 916 and the funnel portion 912, as pills are inserted.

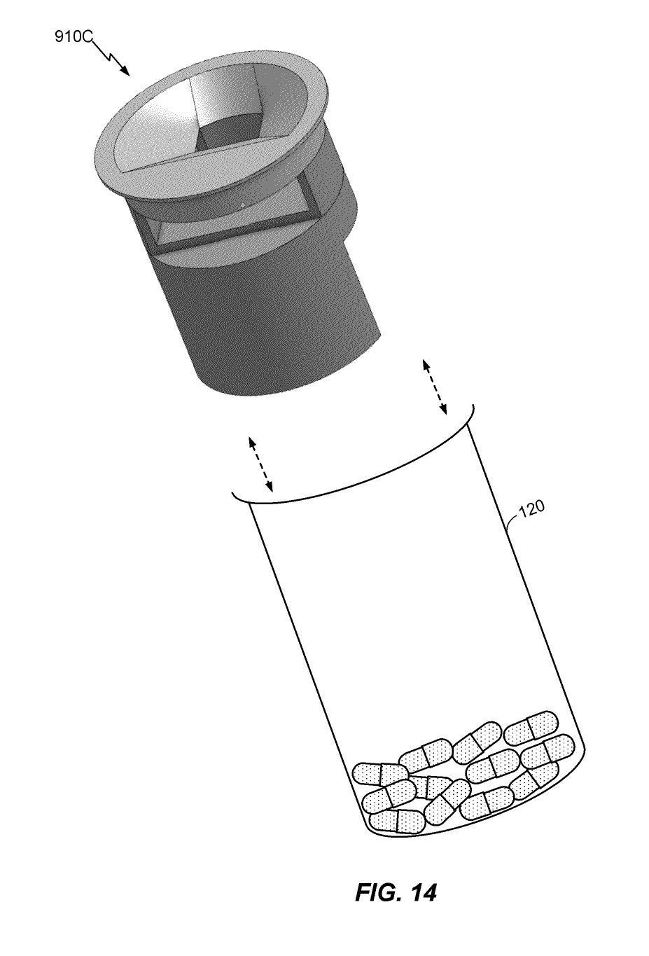

As illustrated in FIGS. 12A and 12B, example mount portions 914A and 914B may also have different sized/shaped openings. For example, the size and shape of openings in mount portions 914A and 914B may be designed to match the size/shape of openings in funnel portions 912A and 912B, respectively. In some embodiments, the mount portion 914A and 914B may also include different positions for the electronics of the smart collar 910. Furthermore, though not shown in this figure, the mount portions 914A and 914B may include different positions for the openings. In some embodiments, the mount portion 914 may comprise different thicknesses for different applications or different containers. In some embodiments, dimensions of the mount portion 914 may be driven by the size of other components, such as the size of a battery and the electronic circuitry powered by the battery.

The top portion 916 may be designed to help guide the pills from the mount portion 914 to the patient (e.g., the patient's hand). Furthermore, in some embodiments, when necessary, the top portion 916 may also provide for the return of excess pills into the container. In some embodiments, dimensions of the top portion 916 may also be driven by the size of other components, such as the size of a battery and the electronic circuitry powered by the battery.

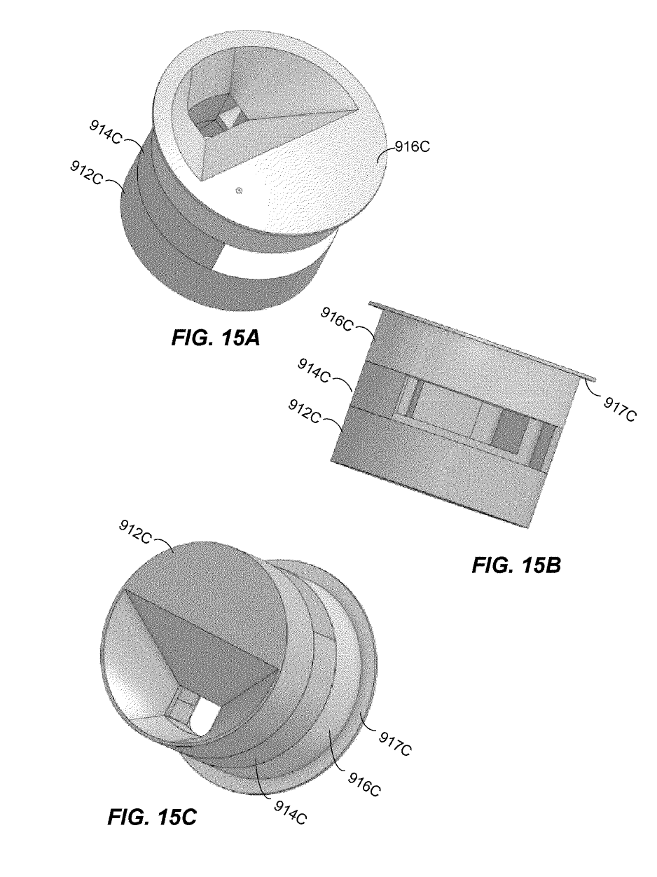

As illustrated in FIGS. 13A and 13B, example top portions 916A and 916B may also have different sized/shaped opening. For example, the size and shape of openings in mount portions 916A and 916B may be designed to match the size/shape of openings in example funnel portions 912A and 912B and example mount portions 914A and 914B, respectively.

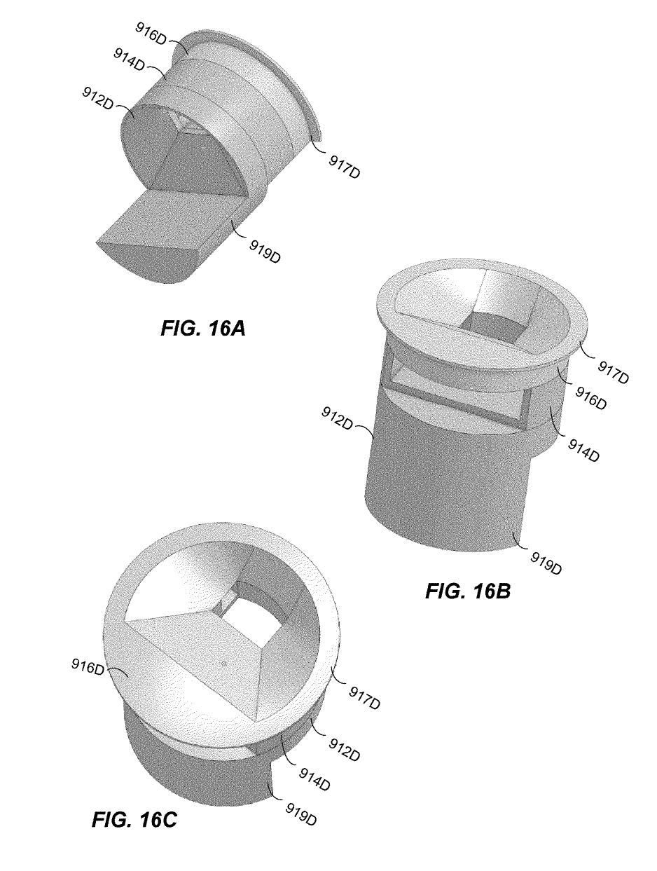

FIG. 14 illustrates another example of a smart collar 910C, in accordance with aspects of the present disclosure. As illustrated, smart collar 910C may fit more completely in container 120, for example, seamlessly integrating with a typical pill bottle. Certain types of bottles (e.g., a conventional pill bottle) may be large enough to support the inclusion of a battery and other electronics in the collar.

As illustrated in FIG. 15A (a top view), FIG. 15B (a side view), and FIG. 15C (a bottom view), smart collar 910C may include a funnel portion 912C designed to be inserted into the container 120, a mount portion 914C, and a top portion 916C. As illustrated, the top portion 916C may have a lip 917C designed to hold the collar on top of the bottle. Top 916C and bottom 914C may each have a “flat” area or other area designed to accommodate the battery and electronics.

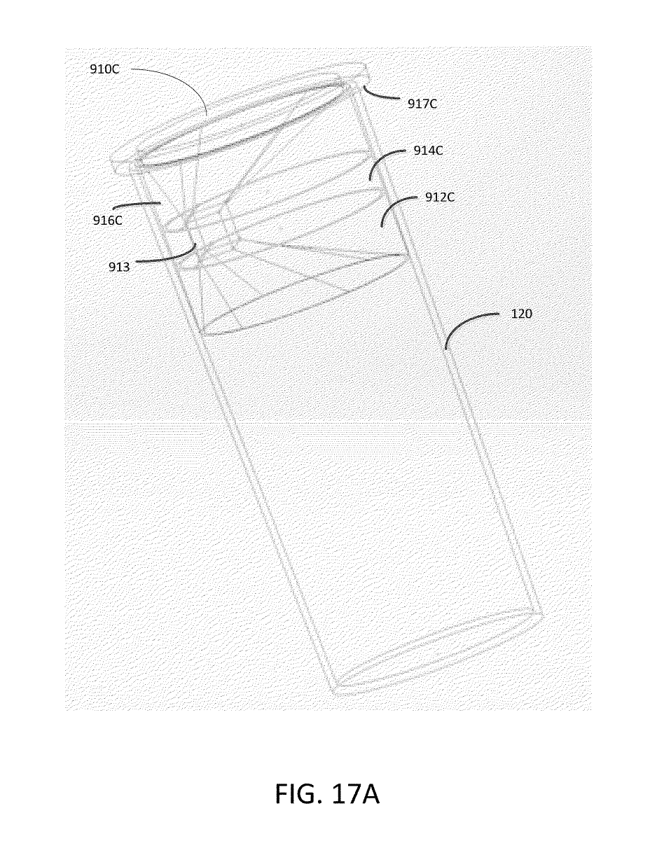

FIGS. 16A-C illustrate another example of a smart collar 910D, in accordance with aspects of the present disclosure. As illustrated, smart collar 910D may include a funnel 912D, mount 914D, and top 916D.

Smart collar 910D may be designed to fit in certain types of containers, such as containers holding drugs that are packaged (pre-packaged) by manufacturers. Such containers may have a smaller opening than conventional pill bottles. As such, smart collar 910D may be designed to fit the smaller opening (and may accommodate a smaller battery). A battery may be placed below the electronics in a specially made extrusion 919D. As shown, the top portion 916D may look the same as top portion 916C described above. In some embodiments, the extrusion 919D may be designed to help the pills within the container 120 to flow to the funnel portion 912.

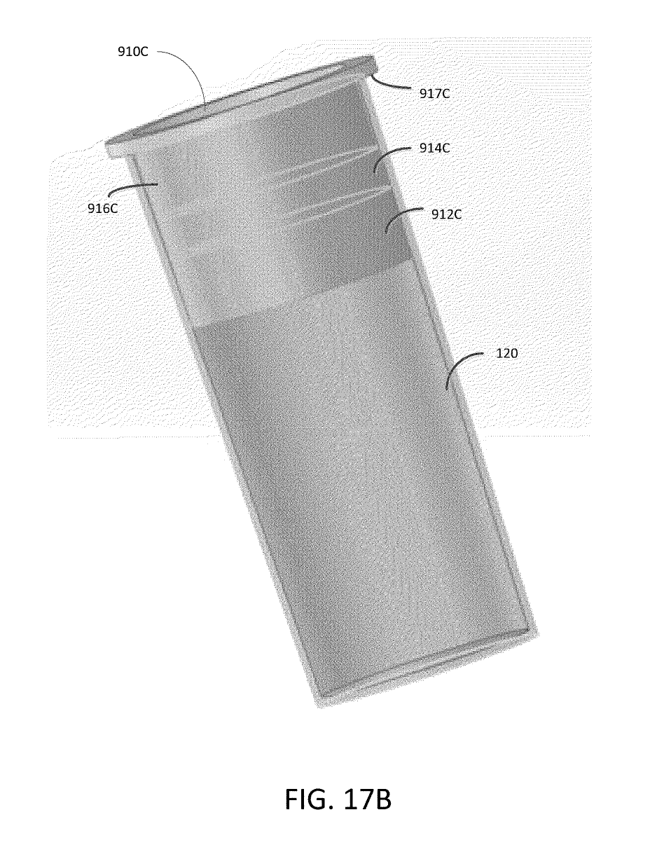

FIGS. 17A-B illustrate the smart collar 910C of FIGS. 15A-C inserted into the container 120 of FIG. 1. As illustrated, smart collar 910C may include a funnel portion 912C, a mount (middle) portion 914C, and a top portion 916C. The funnel portion 912C of the smart collar 910C may be positioned below the mount portion 914C, which may be positioned below the top portion 916C, as further detailed above. The funnel portion 912C and the mount portion 914C may be configured to be inserted entirely into the container 120.

The funnel portion 912C may be configured to funnel pills from inside the container 120 to outside of the container 120 while counting the number of pills that are dispensed from the container 120. For further details of the funnel portion 912C, reference is made in connection with FIG. 9. The mount portion 914C may be configured to house one or more electronic components of the smart collar 910, as is described in more detail above. The top portion 916C may have a lip 917C configured to hold the collar on top of the bottle. By configuring the smart collar 910C to fit more completely in the container 120, the smart collar 910C may seamlessly integrate with a typical pill bottle and minimize changes to a user's experience.

As described above, certain aspects of the present disclosure provide a cloud-based platform that may utilize a smart collar to monitor patient adherence to a medical regimen. The smart collar may provide a relatively low-cost mechanism that seamlessly integrates in existing containers (e.g., standard pill bottles of various sizes) and provides accurate monitoring of medication consumption. This information may be provided to a cloud-based monitoring system to help monitor and promote patient adherence to a regimen which may lead to improved results, potentially increasing wellness and saving both cost and lives.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

As used herein, a phrase referring to “at least one of” a list of items refers to any combination of those items, including single members as well as combinations that may multiples of the same element.

The various operations of methods described above may be performed by any suitable means capable of performing the corresponding functions. The means may include any suitable combination of hardware, software, or both. Examples of such hardware include any suitable circuit or circuitry, such as a processor (e.g., a general-purpose processor, field programmable gate array (FPGA), or application specific integrated circuit (ASIC).

Portions implemented in software may include code or instructions on a computer-readable medium. As used herein, the term software generally refers to any combination of instructions, data, or both, and may include firmware. A computer-readable storage medium may be integral to a processor of coupled to a processor such that the processor can read information from, and write information to, the storage medium. Examples of machine-readable storage media may include, for example, one or more of: any type of Random Access Memory (RAM), Read Only Memory (ROM), or any other suitable storage medium.

It is to be understood that the claims are not limited to the precise configuration and components illustrated above. Various modifications, changes and variations may be made in the arrangement, operation and details of the methods and apparatus described above without departing from the scope of the claims.

What is claimed:

1. An apparatus for tracking a count of objects in a container, comprising:
a first portion adapted to be inserted within an opening of the container, the first portion having one or more surfaces adapted to guide the objects toward an opening in the first portion, the opening having a size configured to allow the objects to pass through the first portion, wherein one of the one or more surfaces has a slope that is different than another one of the one or more surfaces, the slope being determined relative to a common geometric plane;
a detector circuit configured to:
detect removal of at least one object from the container as the object passes through the opening, and
generate a first signal in response to the detected removal of the at least one object; and
a processor configured to update a count of the objects in the container based on the first signal.

2. The apparatus of claim 1, wherein the objects comprise pills and the container comprises a pill bottle.

3. The apparatus of claim 1, wherein the first portion comprises one or more components configured to control a flow of the objects and wherein the opening in the first portion is sized to control the flow of the objects.

4. The apparatus of claim 1, further comprising an interface circuit for transmitting a wireless signal indicative of at least one of a monitored count or a change in the monitored count.

5. The apparatus of claim 4, wherein the apparatus comprises a second portion above the first portion, the second portion comprising the detector circuit, the processor, and the interface, and wherein the second portion has an opening sized to match the opening of the first portion.

6. The apparatus of claim 5, further comprising a third portion above the second portion, the third portion having surfaces adapted to guide objects to an opening in the third portion aligned with the opening in the first portion and the opening in the second portion when objects are added to the container.

7. The apparatus of claim 6, wherein dimensions and slopes of the surfaces of the third portion are substantially similar to and a mirror image of dimensions and slopes of the one or more surfaces of the first portion.

8. The apparatus of claim 1, wherein the apparatus comprises a lip portion adapted to hold the apparatus flush at the top of the container.

9. The apparatus of claim 1, wherein one of the one or more surfaces of the first portion comprise little or no protrusions on an exposed region of the one or more surfaces.

10. The apparatus of claim 1, wherein the one or more surfaces of the first portion are smooth, the one or more surfaces having a coefficient of friction that is appropriate to allow the objects to be removed from the container.

11. The apparatus of claim 1, wherein at least one of the one or more surfaces is curved.

12. The apparatus of claim 1, wherein the one or more surfaces of the first portion are configured such that a cross section of an end of the first portion is circular and a cross section at another end of the first portion comprises a substantially rectangular opening.

13. The apparatus of claim 1, wherein the slopes of the one or more surfaces are dependent on the size and/or shape of the objects.

14. A method for tracking a count of objects in a container, the method comprising:
inserting a first portion at an opening of the container, the first portion having one or more surfaces adapted to guide the objects toward an opening in the first portion, the opening having a size configured to allow the objects to pass through the first portion, wherein one of the one or more surfaces has a slope that is different than another one of the one or more surfaces, the slope being relative to a common geometric plane;
detecting removal of at least one object from the container as the object passes through the opening;
generating a first signal in response to the detected removal of the at least one object; and
updating a count of the objects in the container based on the first signal.

15. The method of claim 14, wherein the slopes of the first portion increase as pill size increases.

16. The method of claim 14, further comprising housing a detector circuit, a processor, and an interface within a second portion, wherein the second portion has an opening sized to match the opening in the first portion.

17. The method of claim 14, further comprising inserting objects into the container via a third portion, the third portion having surfaces adapted to guide objects from an opening in the third portion aligned with the opening in the first portion and the opening in the second portion.

18. An apparatus for tracking a count of objects in a container, comprising:
means for funneling the objects in the container, the funneling means configured to guide the objects toward an opening in the funneling means, the opening having a size configured to allow the objects to pass therethrough, the funneling means comprising one or more surfaces, wherein one of the one or more surfaces has a slope that is different than another one of the one or more surfaces, the slope being relative to a common geometric plane;
means for detecting removal of at least one object from the container as the object passes through the opening;
means for generating a first signal in response to the detected removal of the at least one object; and
means for updating a count of the objects in the container based on the first signal.

19. The apparatus of claim 18, further comprising means for inserting objects into the container, the inserting means having surfaces adapted to guide objects from outside the container to an opening in the inserting means that is aligned with the opening in the funneling means.
